(19) United States
(12) Patent Application Publication
(10) Pub. No.: US 2005/0202128 A1
(43) Pub. Date: Sep. 15, 2005

(54) Edible toothpick

(76) Inventor: Kevin P. Dittimus, Rancho Cordova, CA (US)

Correspondence Address: Kevin P. Dittimus, 10521 Chardonay Drive, Rancho Cordova, CA, 95670, US

(21) Appl. No.: 10/801,378

(22) Filed: Mar. 15, 2004

(51) Int. Cl. A23G 1/00

(52) U.S. Cl. 426/104

(57) ABSTRACT

The edible toothpick is a toothpick that can be consumed along with foods mounted on it or after the food mounted on it is consumed. These edible toothpicks can be produced from a variety of nuts, grains, fruits, and/or vegetables as well as in a variety of flavors that will add an additional flavor element to foods mounted on the edible toothpick. Edible toothpicks, since they can be consumed along with foods mounted on them, virtually eliminate clean up associated with wooden toothpicks as well as the health and safety issues associated with wooden toothpicks.

### BACKGROUND OF THE INVENTION

For years, the wooden toothpick has been a standard item at backyard barbeques, Super Bowl parties, family gatherings, and other occasions as a convenient method for serving foods on for consumption. However, there are several negatives associated with using wooden toothpicks to serve foods with. One negative associated with wooden toothpicks is that at the conclusion of a party or gathering, the host has to contend with cleaning up a multitude of used toothpicks left over by guests. These used wooden toothpicks present a safety issue for younger children since they could injure themselves with the sharp edges of toothpicks they come in contact with. Used wooden toothpicks also present sanitary and health issues due to germs being present on them after they have been inserted inside the mouths of someone eating food mounted on them.

The edible toothpick is an invention that solves the issues of cleanup of toothpicks after parties as well as the aforementioned health and safety issues associated with wooden toothpicks. Since the invention is an edible toothpick vs a wooden toothpick, cleanup after parties is virtually eliminated since the edible toothpick can be consumed along with the food mounted on it or after the food mounted on it is consumed. Lastly, the edible toothpick (unlike the wooden toothpick) can be utilized to add an extra flavor element to foods mounted on them since they can be made from various nuts, grains, fruits and/or vegetables as well as in various flavors.

### BRIEF SUMMARY OF THE INVENTION

The edible toothpick can be consumed along with foods that are mounted on it or after the food mounted on it is consumed. Since the toothpick is edible, it will virtually eliminate hosts having to clean up toothpicks after a gathering is over as well as eliminate the health and safety issues associated with wooden toothpicks such as germs being present on them after they are used and younger children getting insured by wooden toothpicks they come in contact with. In addition, the edible toothpicks can be produced in a wide variety of flavors as well as from a wide variety of nuts, grains, fruits, and/or vegetables to add an additional flavor element to foods mounted on them.

### DESCRIPTION OF DRAWINGS

FIG. 1 is a view of the Edible Toothpick;

FIG. 2 is a view of the Edible Toothpick made longer and thicker to accommodate the mounting of larger sizes and amounts of foods;

FIG. 3 is a view of the Edible Toothpick with food mounted on it;

FIG. 4 is a view of a longer and thicker version of the Edible Toothpick with food mounted on it.

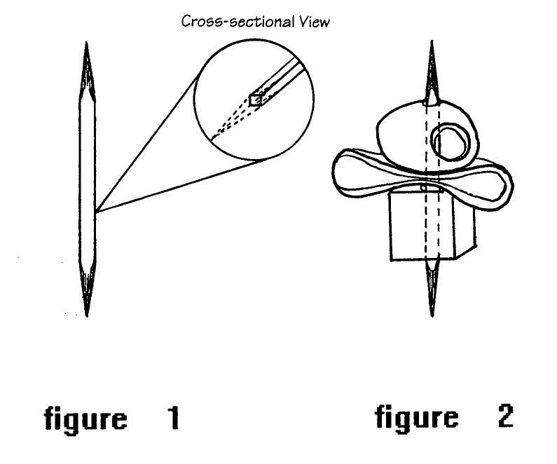

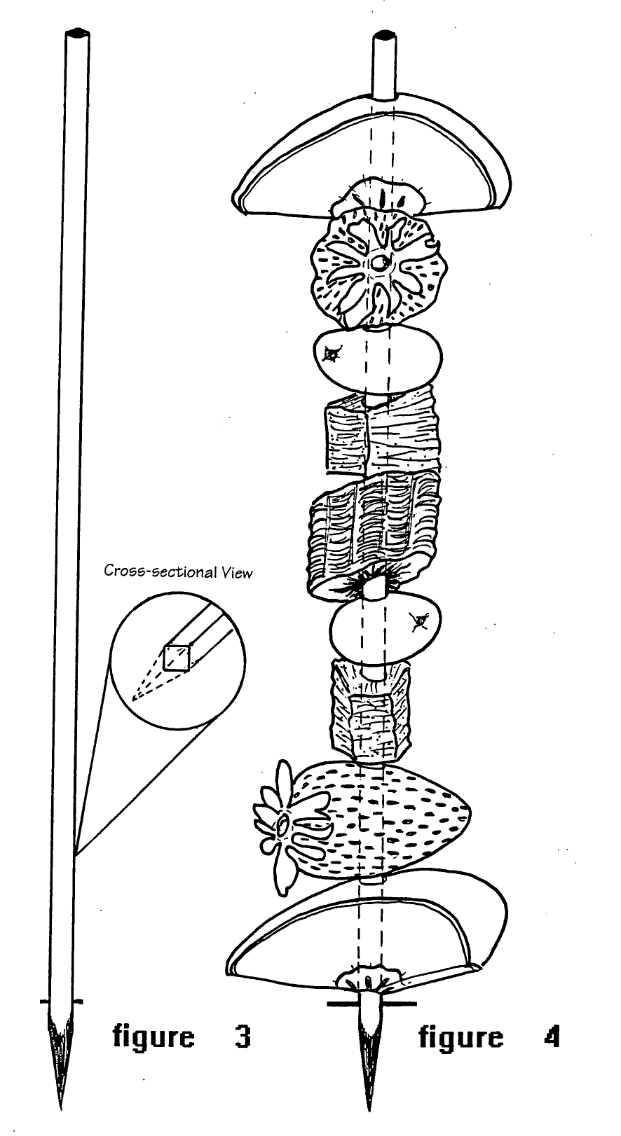

### DETAILED DESCRIPTION OF THE INVENTION

The edible toothpick is a toothpick that can be consumed along with the food mounted on it or after the food mounted on edible toothpick is consumed. The invention can be produced from a variety of nuts, grains, fruits, and/or vegetables including, but not limited to almonds, corn, wheat, tomato, potato, and/or rice. The edible toothpick can also be produced in a variety of flavors which include but are not limited to barbeque, ranch, taco, or cheese. These flavors of edible toothpicks as well as the nuts, grains, fruits, and/or vegetables they are produced from can also add an additional flavor element to foods mounted on the edible toothpick. In addition, the edible toothpick can also be produced in a variety of thicknesses and lengths to accommodate various sizes and weights of foods to be mounted on them.

1. Edible toothpick that can be consumed along with foods that are mounted on it or after the food mounted on it is consumed.

2. Edible toothpick produced from a variety of nuts, fruits, vegetables, and/or grains which add an additional flavor element to foods served with the edible toothpick.

3. Edible toothpick produced in a variety of flavors that add an additional flavor element to foods served with the edible toothpick.

4. Edible toothpick that eliminates cleanup after parties since they are consumed along with the foods mounted on them or after the food mounted on it is consumed.

5. Edible toothpick that virtually eliminates the health and safety issues associated with wooden toothpicks such as contact with germs left on wooden toothpick after they have been inserted inside the mouths of people eating food from the wooden toothpick and younger children being injured when they come in contact with sharp edges of used wooden toothpicks.
